(19) United States
(12) Patent Application Publication
(10) Pub. No.: US 2020/0011402 A1
(43) Pub. Date: Jan. 9, 2020

(54) ANTI-EJECTION DEVICE FOR HYDRAULIC TENSIONER

(71) Applicant: BorgWarner Inc., Auburn Hills, MI (US)

(72) Inventor: Fabio MAGNI, Monza (IT)

(21) Appl. No.: 16/494,869

(22) PCT Filed: Mar. 20, 2017
(86) PCT No.: PCT/US2017/023184

§ 371 Date: Sep. 17, 2019

(51) Int. Cl. F16H 7/08

(52) U.S. Cl. CPC F16H 7/0848; F16B 21/18; F16H 2007/0855

(57) ABSTRACT

A hydraulic tensioner includes a tensioner housing having a bore extending a length, with a slot along the length of the bore. A hollow piston is slidably received within the bore and has an outer circumference with a chamfer adjacent a formed edge. An expandable circlip is received by the outer circumference of the piston. The circlip includes a substantially clover shaped body with a plurality of lobes connected to a first leg and a second leg through connecting portions. The expandable circlip has a free state, in which the lobes of the circlip are engaged with at least the chamfer of the piston, and an expanded state, in which the first leg and the second leg are moved away from each other, disengaged from the chamfer. When the expandable circlip is in the free state, the piston is prevented from being ejected from the bore of the housing.

### BACKGROUND OF THE INVENTION

### Field of the Invention

The invention pertains to the field of hydraulic tensioners. More particularly, the invention pertains to an anti-ejection device for a hydraulic tensioner.

### Description of Related Art

In chain and belt tensioners, pistons are urged from their housings by a spring or a spring plus hydraulic pressure. Check valves are added to tensioners between the pressurized fluid source and the fluid chamber formed in the bore between the housing and the piston, to prevent backflow of the hydraulic fluid out of the fluid chamber. The rate of leakage through the clearance between the piston and the bore allows the retraction of the piston as makeup fluid subsides or ceases. As the rate of leakage increases, the resistance to retraction of the piston lessens and as the rate of leakage decreases, the resistance to retraction of the piston increases. When chain load spikes or a loss of fluid pressure is present, retraction of the plunger occurs and, if the retraction of the plunger is excessive, loss of chain control, loss of engine time or other undesirable effects occur. Therefore, limiting the amount of piston retraction is desirable.

The common practice of tuning a tensioner to a system by changing the fluid leak rate occasionally results in a desired normal state piston retraction, which exceeds what is desired during startup or engine operation and shutdown. Tuning a tensioner to properly control system dynamics may also result in excessive piston extension or pump-up that may cause high chain loading or piston binding. This often results in a tensioner tune that is less than optimal in order to prevent the piston from extending beyond the allowable limit.

### SUMMARY OF THE INVENTION

A hydraulic tensioner includes a tensioner housing having a bore extending a length, with a slot along the length of the bore. A hollow piston is slidably received within the bore and has an outer circumference with a chamfer adjacent a formed edge. An expandable circlip is received by the outer circumference of the piston. The circlip has a substantially clover shaped body with a plurality of lobes connected to a first leg and a second leg through connecting portions. The expandable circlip has a free state in which the lobes of the circlip are engaged with at least the chamfer of the piston and an expanded state, in which the first leg and the second leg are moved away from each other, disengaged from the chamfer. When the expandable circlip is in the free state and engaged with the chamfer and edge of the piston, the piston is prevented from ejecting from the bore of the housing.

The expandable circlip preferably has at least three lobes connected to a first leg and a second leg through connecting portions.

### BRIEF DESCRIPTION OF THE DRAWINGS

FIG. 1 shows a side view of a hydraulic tensioner of the present invention.

FIG. 2 shows a top view of the hydraulic tensioner of the present invention.

FIG. 3 shows a perspective view of the hydraulic tensioner of the present invention.

FIG. 4 shows a sectional view of the housing of the hydraulic tensioner of the present invention.

FIG. 5 shows a top view of the circlip and the housing of the hydraulic tensioner of the present invention.

FIG. 6 shows a sectional view of the piston and circlip within the housing of the hydraulic tensioner with the piston in a mounting position.

FIG. 7 shows a top view of the piston and circlip within the housing, with the piston in the mounting position.

FIG. 8 shows a sectional view of the piston and circlip within the housing, with the piston in an anti-ejection position.

FIG. 9 shows a top view of the piston and circlip within the housing, with the piston in an anti-ejection position.

FIG. 10 shows a sectional view of the piston and circlip within the housing, with the piston in a working position.

FIG. 11 shows a top view of the piston and circlip within the housing, with the piston in a working position.

FIG. 12 shows a perspective view of the piston and circlip of the hydraulic tensioner of the present invention.

FIG. 13 shows a top view of an anti-ejection circlip in an embodiment of the present invention in a resting position.

FIG. 14 shows a perspective view of the anti-ejection circlip of FIG. 13.

FIG. 15 shows a top view of an anti-ejection circlip in another embodiment of the present invention in a deformed position.

FIG. 16 shows a perspective view of the anti-ejection circlip of FIG. 15 in a deformed position.

FIG. 17 shows a top view of an anti-rejection circlip in an alternate embodiment in a deformed position.

FIG. 18 shows a perspective view of the anti-rejection circlip of FIG. 17 in a deformed position.

### DETAILED DESCRIPTION OF THE INVENTION

The tensioner systems of the present invention include a tensioner 101 (described in further detail below) for a closed loop chain drive system used in an internal combustion engine. It may be utilized on a closed loop power transmission system between a driveshaft and at least one camshaft or on a balance shaft system between the driveshaft and a balance shaft. The tensioner system may also include an oil pump and be used with fuel pump drives. Additionally, the tensioner system of the present invention may also be used with belt drives.

A hydraulic tensioner includes an anti-ejection circlip, piston and tensioner housing. The anti-ejection circlip prevents piston ejection from the tensioner housing. The circlip is mounted in a slot of the housing. Deformation of the circlip allows piston mounting within the tensioner housing. When the circlip is received within a chamfer on the piston, the circlip can prevent the piston from ejecting from the tensioner housing.

It should be noted that by mounting the circlip on the piston instead of the housing, the friction between the circlip and the housing is significantly reduced, reducing wear on the housing. The reduction in wear on the housing is especially useful when the housing is made of a softer metal, such as aluminum.

The anti-ejection circlip is preferably made of steel, although other materials such as plastic may be used. The anti-ejection circlip may be a flat metal strip or a rounded metal which is shaped to achieve a clover or lobed geometry. The circlip preferably allows for some deformation and may include spring-like properties, such that the circlip can be deformed and return to a free state.

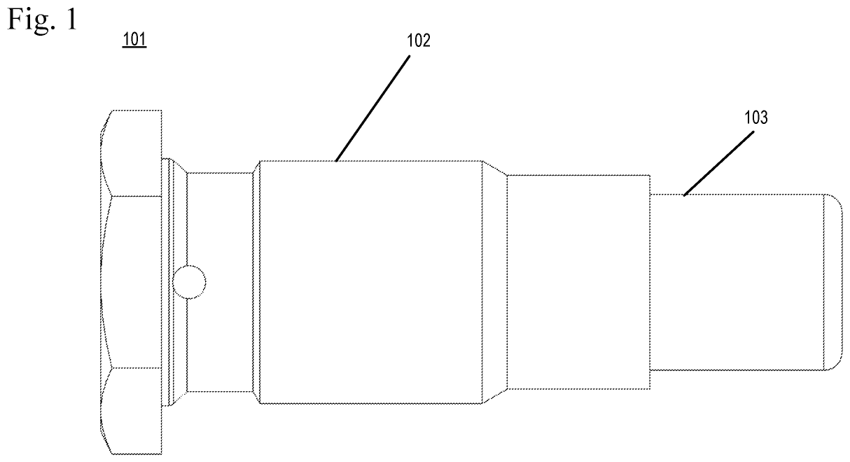

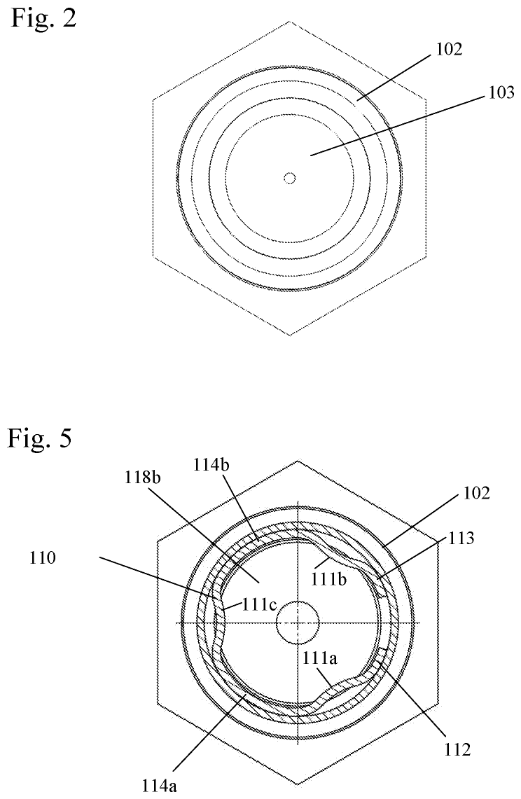

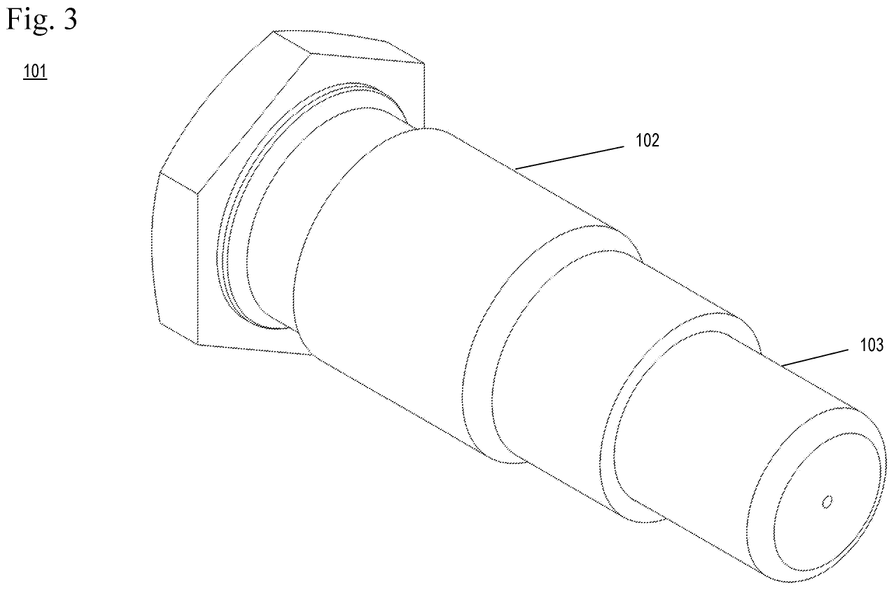

FIGS. 1-12 show a hydraulic tensioner 101 in an embodiment of the present invention. The hydraulic tensioner 101 has a housing 102 with a bore 118 having a first open end 118a and a second end 118b. The second end 118b of the bore 118 is in fluid communication with an inlet 109 connected to a source (not shown). A check valve (not shown) may be present between the bore 118 and the inlet 109, preventing the flow of fluid from the bore 118 into the inlet 109.

The first open end 118a of the bore 118 has a slot 107 which can receive an anti-ejection circlip 110. The first open end 118a also slidably receives a hollow piston 103. The hollow piston 103 has a closed end 103a for contacting a closed loop chain or belt and an open end 103b with a mounting chamfer 120 on an outer surface 119. The open end 103b of the hollow piston 103 has an inner circumference 104. The closed end 103a can also have a vent 117 to reduce the volume and the pressure of fluid present in a pressure chamber formed between the inner circumference 104 of the hollow piston 103 and the bore 118 of the housing 102. While not shown, other items may be present within the pressure chamber, such as a spring, vent disk, and/or other conventional items.

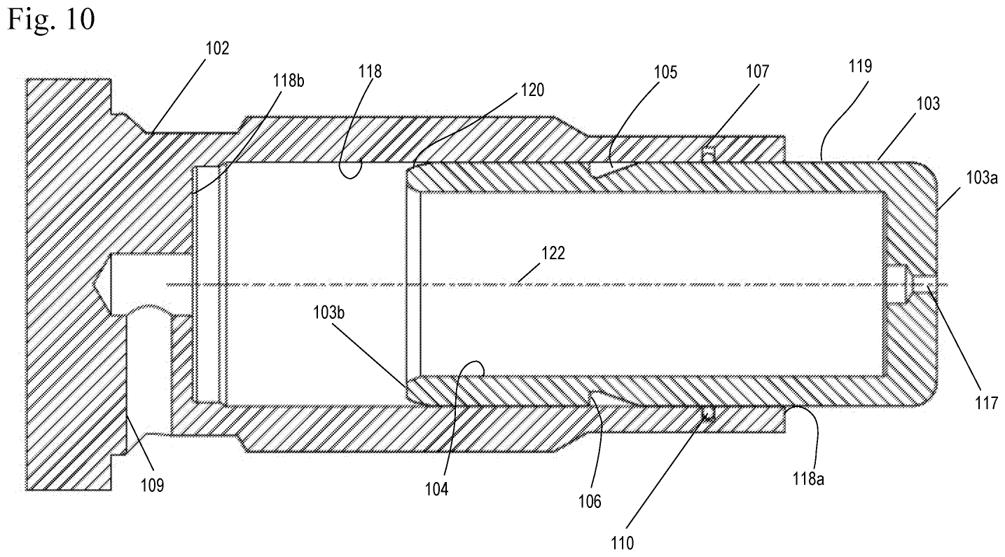

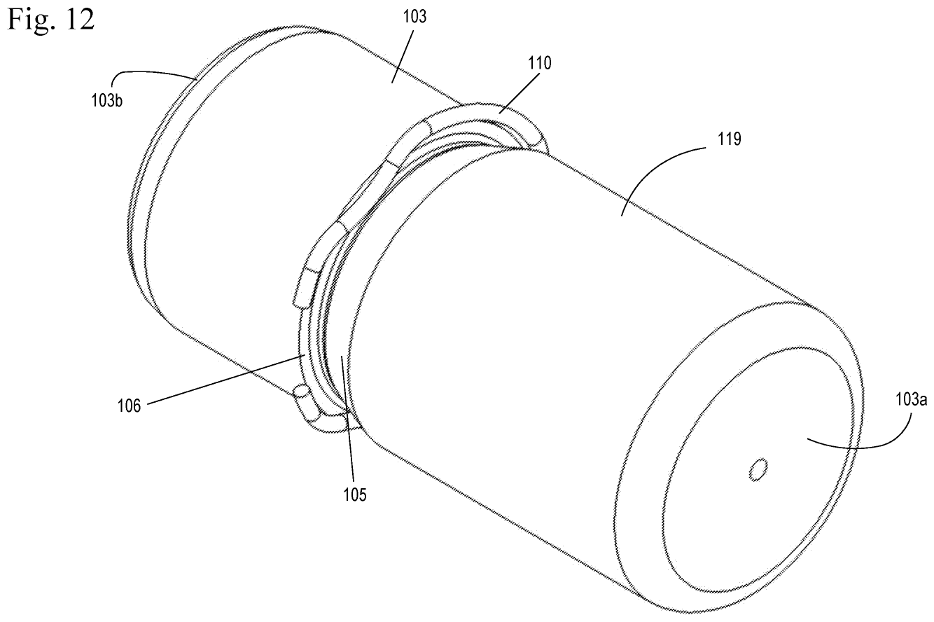

Referring to FIG. 12, the piston 103 has a chamfer 105 around an outer circumference 119 for slidably receiving the anti-ejection circlip 110. The angled corner or edge 106 adjacent the chamfer 105 and the shape of the anti-ejection circlip 110 prevent the piston 103 from ejecting out of the housing 102 of the tensioner 101. The edge is preferably perpendicular to a centerline 122 of the piston 103 (see FIG. 10). The angle of the of the corner or edge may vary from the angle shown in the drawings and based on the application. It should also be noted that that the chamfer 105 may be placed anywhere along the outer circumference of the piston 103 and is not limited to the placement shown in the drawings.

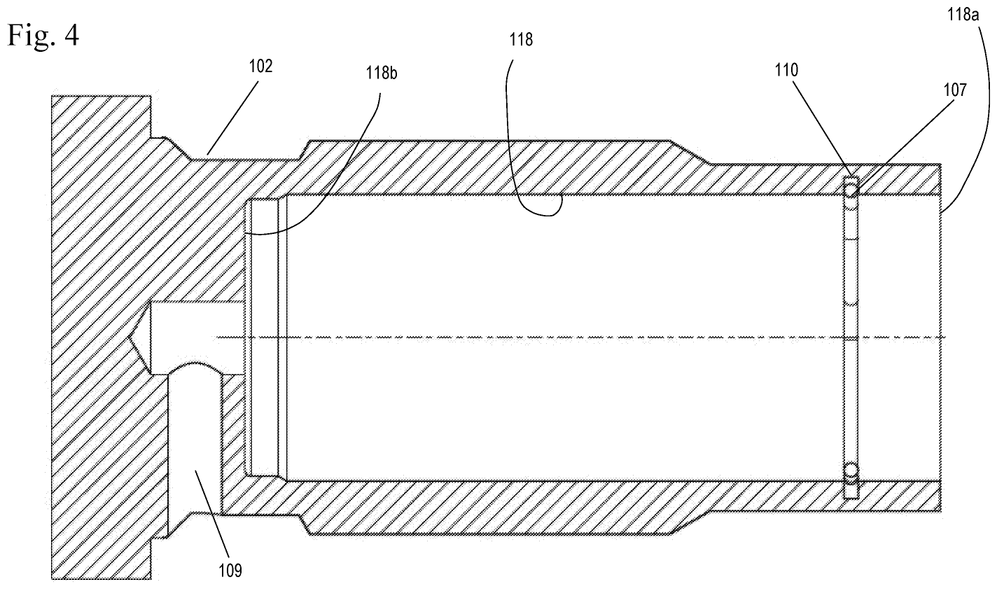

The anti-ejection circlip 110, 116, 121 has an expandable clover shaped body with a plurality of lobes 111 connected to legs through connecting portions. It should be noted that while anti-ejection circlip 110 is shown in FIGS. 4-12, anti-ejection circlip 116, 121 can replace anti-ejection circlip 110.

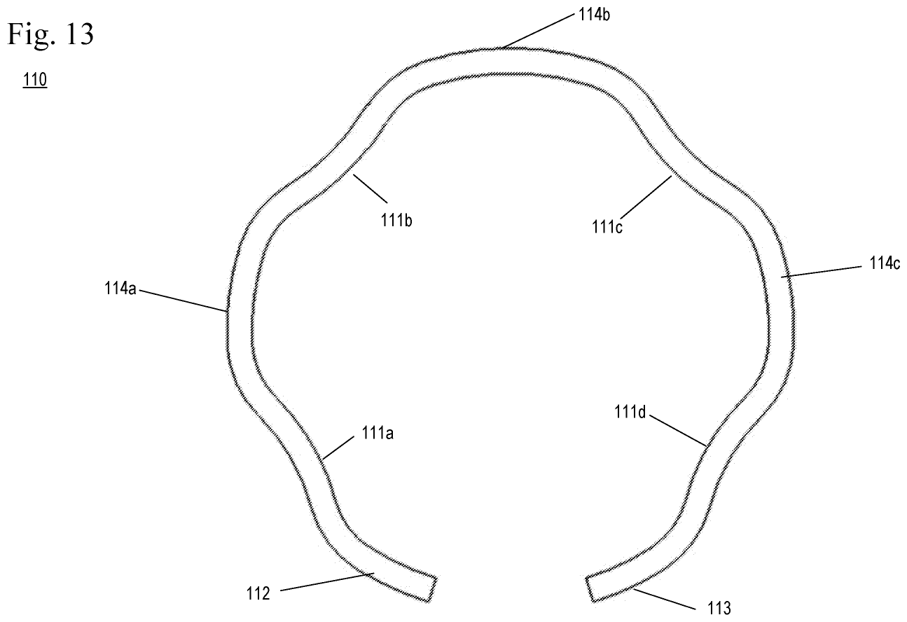

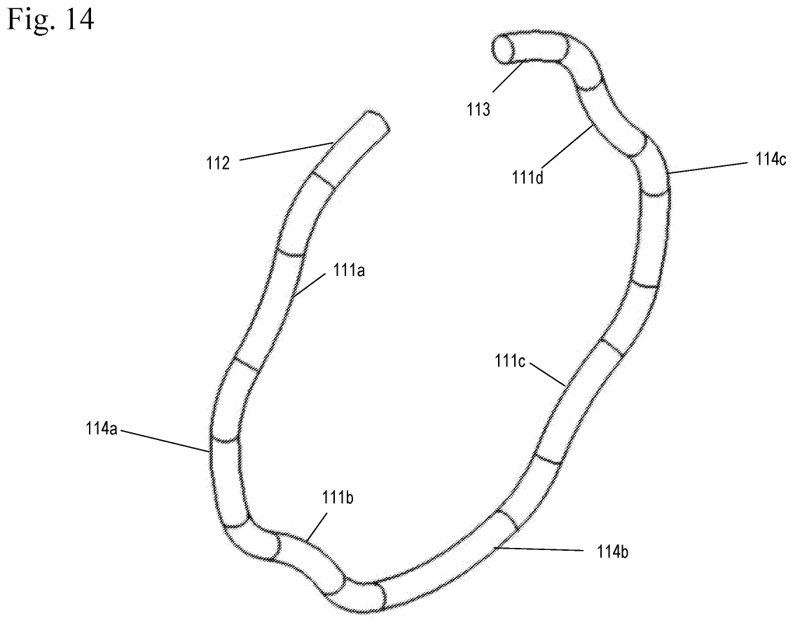

In one embodiment, the anti-ejection circlip 110 is made of steel wire as shown in FIGS. 13-14. In this embodiment, the circlip 110 is preferably shaped, such that a first leg 112 is connected to a first lobe 111a extending inwards, the first lobe 111a is connected to a connecting portion 114a extending outwards, the connecting portion 114a is connected to a second lobe 111b extending inwards, the second lobe 111b is connected to another connecting portion 114b extending outwards, the connecting portion 114b is connected to a third lobe 111c extending inwards, the third lobe 111c is connected to another connecting portion 114c extending outwards, the connecting portion 114c is connected to a fourth lobe 111d, extending inwards, which is connected to a second leg 113. The first leg 112 connects to the second leg 113 through the lobes 111a-111d and the connecting portions 114a-114c. The lobes 111a-111d can be deformed (expanded state) and pushed by the outer circumference 119 of the piston 103 to a position in which the lobes 111a-111d are in line with the connecting portions 114a-114c, moving the first leg 112 away from the second leg 113.

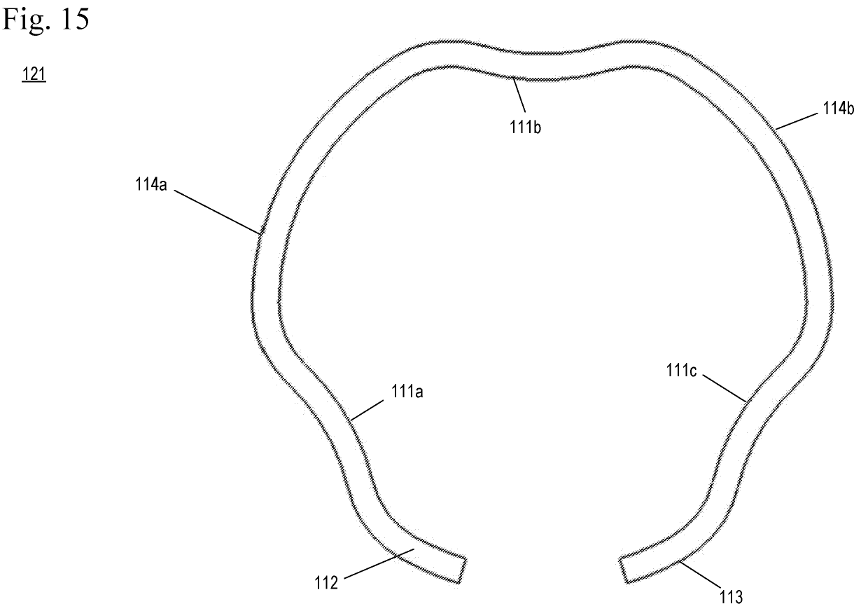

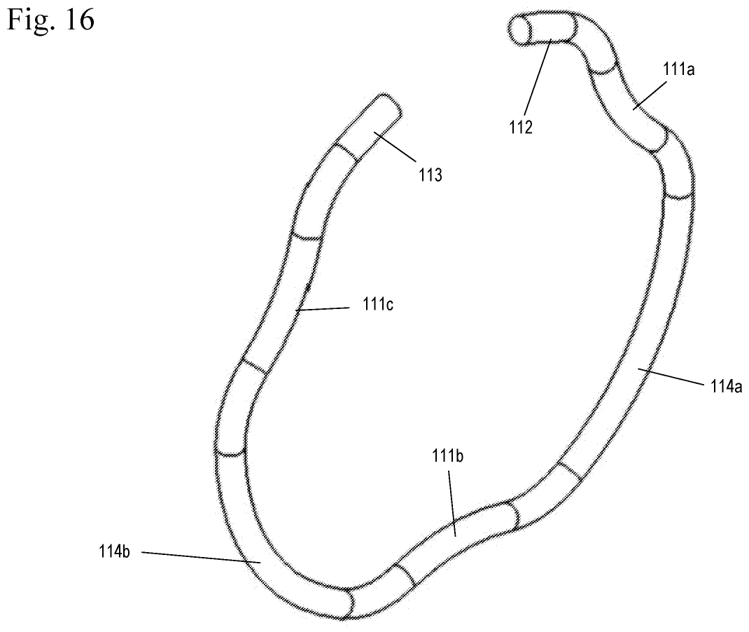

In another embodiment, as shown in FIGS. 15-16, the anti-ejection circlip 121 is made of steel wire and has only three lobes 111a-111c and two connecting portions 114a-114b, instead of four lobes and three connecting portions as described above. The anti-ejection circlip 121 is preferably shaped, such that a first leg 112 is connected to a first lobe 111a extending inwards, the first lobe 111a is connected to a connecting portion 114a extending outwards, the connecting portion 114a is connected to a second lobe 111b extending inwards, the second lobe 111b is connected to another connecting portion 114b extending outwards, the connecting portion 114b is connected to a third lobe 111c extending inwards, and the third lobe 111c is connected to a second leg 113. The first leg 112 connects to the second leg 113 through the lobes 111a-111c and the connecting portions 114a-114b. The lobes 111a-111c can be deformed (expanded state) and pushed by the outer circumference 119 of the piston 103 to a position in which the lobes 111a-111c are in line with the connecting portions 114a-114b, moving the first leg 112 away from the second leg 113.

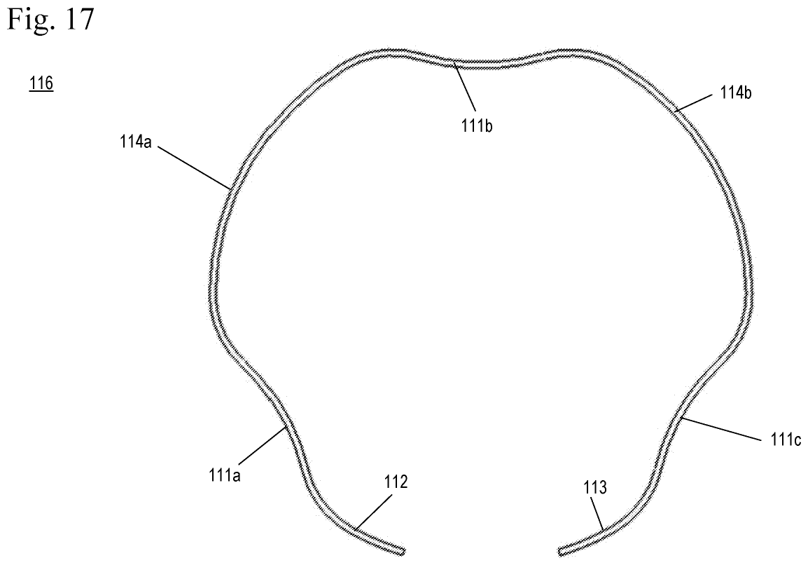

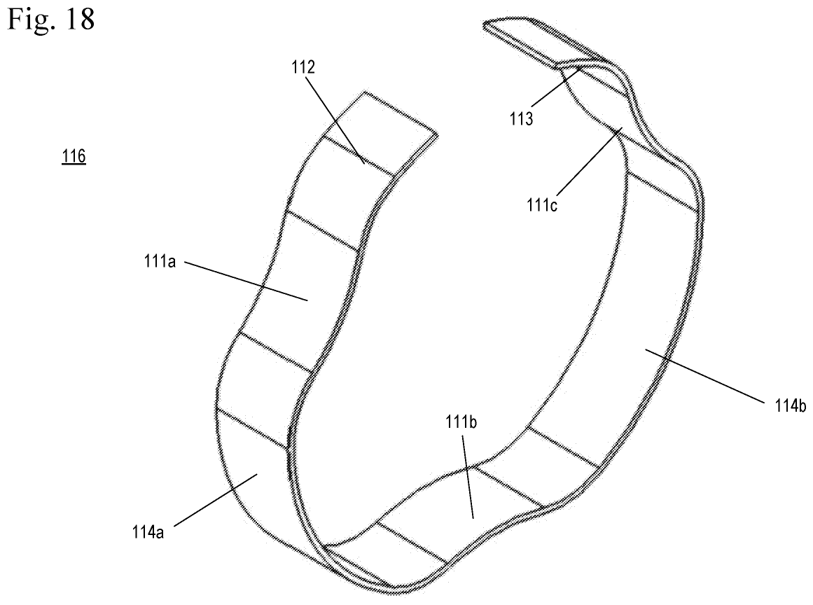

In an alternate embodiment, the anti-ejection circlip 116 is made of a steel band as shown in FIGS. 17-18. The anti-ejection circlip 116 preferably has at least three lobes 111a-111c connected together by connection portions 114a-114b. The circlip 116 is preferably shaped, such that a first leg 112 is connected to a first lobe 111a extending inwards, the first lobe 111a is connected to a connecting portion 114a extending outwards, the connecting portion 114a is connected to a second lobe 111b extending inwards, the second lobe 111b is connected to another connecting portion 114b extending outwards, the connecting portion 114b is connected to a third lobe 111c extending inwards, and the third lobe 111c is connected to a second leg 113. The first leg 112 connects to the second leg 113 through the lobes 111a-111c and the connecting portions 114a-114b. The lobes 111a-111c can be deformed (expanded state) and pushed by the outer circumference 119 of the piston 103 to a position in which the lobes 111a-111c are in line with the connecting portions 114a-114b, moving the first leg 112 away from the second leg 113.

The anti-ejection circlips 110, 116, 121 have a free state in which the lobes 111 of the body extend inwards as shown in FIG. 5. When the piston 103 is present within the bore 118 of the housing 102, the lobes 111 of the anti-ejection circlips 110, 116, 121 engage the outer circumference 119 of the piston 103. If the anti-ejection circlip 110, 116, 121 is engaged with the chamfer 105, or between the chamfer 105 and the edge 106, the lobes 111 of the anti-ejection circlip 110, 116, 121 are in a free state and extend inwards as shown in FIG. 9. The engagement of the lobes 111 with the chamfer 105 and the edge 106 prevent further movement of the piston 103 outwards from the housing 102 and thus prevent ejection of the piston 103 from the bore 118 of the housing 102.

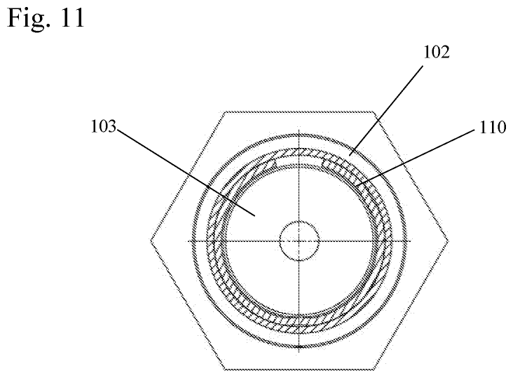

When the anti-ejection circlip 110, 116, 121 is engaged with the outer circumference 119 of the piston 103 other than the chamfer 105 or edge 106, the outer circumference 119 of the piston deforms the lobes 111, such that they have approximately the same shape or curve of the connection portions 114 as shown in FIG. 11 and the circlip is in an expanded state.

It should be noted that while the anti-ejection circlips are described as having a specific number of lobes and connecting portions, the number of lobes may vary. The anti-ejection circlip can have two lobes with a connecting portion between the first leg and the second leg. The anti-ejection circlip can also have greater than four lobes with associated connecting portions between the first leg and the second leg.

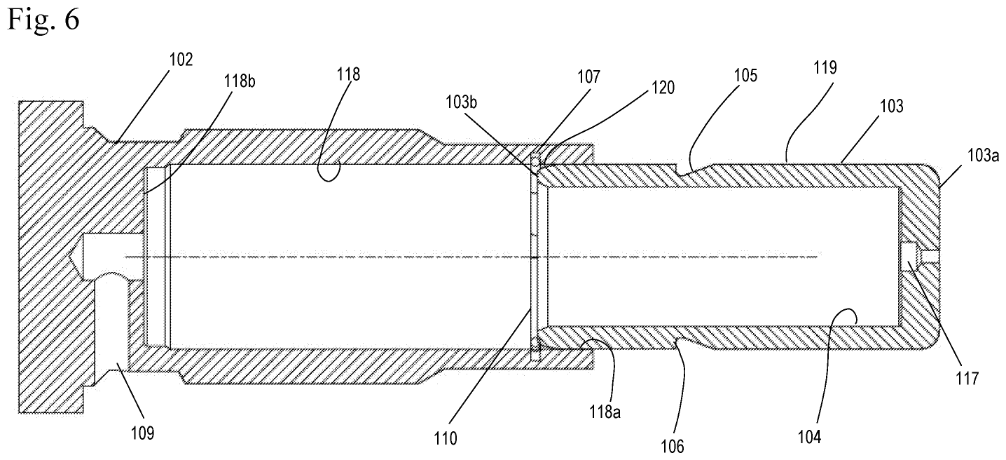

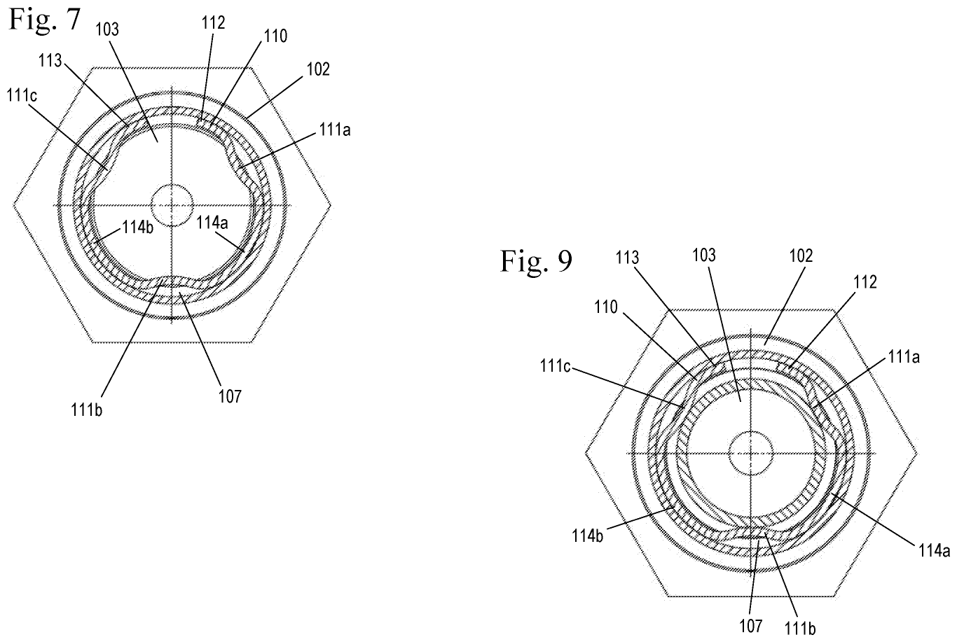

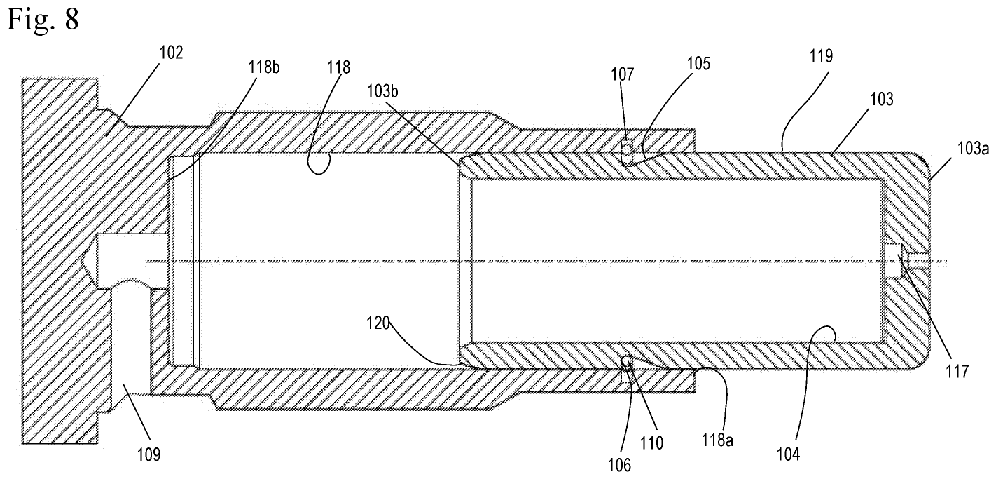

FIGS. 6-7 show the piston 103 being mounted to the tensioner housing 102. In this position, the anti-ejection circlip 110 is present within the slot 107 of the bore 118 of the housing 102 in a resting state, prior to insertion of the piston 103. The piston 103 is then inserted into the bore 118 of the housing 102, such that the lobes 111a-111d of the anti-ejection circlip 110 engages the mounting chamfer 120 on the open end 103b of the piston 103. After the anti-ejection circlip 110 has expanded to encircle the outer circumference 119 of the piston 103, the piston 103 moves inwards towards the inlet 109 until the anti-ejection circlip 110 is received with the chamfer 105 on the outer circumference 119 of the piston 103 as shown in FIGS. 8-9.

FIGS. 8-9 show the anti-ejection circlip 110 preventing the ejection of the piston 103 from the housing 102. The piston 103 is prevented from moving further outwards or away from the inlet 109 by the contact of the lobes 114a-114d of the anti-ejection circlip 110 with the edge 106 and the chamfer 105.

FIGS. 10-11 show the anti-ejection circlip 110 present within the slot 107 of the inner circumference 118 of the housing 102 with the lobes 114a-114d of the anti-ejection circlip 110 in a deformed state, such that the curve of the lobes 114a-114d is approximately the same as the connecting portions 111a-111c between the lobes 114a-114d of the circlip 110. In this state, the piston 103 can slide within the bore 118 of the housing 102 outwards from the housing 102 to tension the chain (not shown), until the chamfer 105 of the piston 103 aligns with the slot 107 of the inner circumference 118 of the housing 102 and the anti-ejection circlip 110 engages the edge 106 adjacent the chamfer 105.

When the anti-ejection circlip 110 engage the chamfer 105 of the piston 103 and there is contact between the edge 106 adjacent the chamfer 105 and anti-ejection circlip 110, the piston 103 can't slide within the bore 118 of the housing 102 outwards from the housing 102, but can slide in opposite direction due to deformation of the anti-ejection circlip 110 to engage the chamfer 105 and the outer circumference 119 of the piston 103.

It should be noted that the anti-ejection circlip 110 is always engaged in the slot 107 on the inner circumference 118 of the housing 102 and that the anti-ejection circlip 110 does not move axially long 122 center line in all the piston 103 positions.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A hydraulic tensioner, comprising:
a tensioner housing having a bore extending a length, with a slot along the length of the bore;
a hollow piston slidably received within the bore, with an outer circumference comprising a chamfer adjacent a formed edge; and
an expandable circlip received by the outer circumference of the piston, the circlip comprising a substantially clover shaped body with at least two lobes connected to a first leg and a second leg through connecting portions, the expandable circlip having a free state, in which the at least two lobes of the circlip are engaged with at least the chamfer of the piston, and an expanded state, in which the first leg and the second leg are moved away from each other, disengaged from the chamfer;
wherein when the expandable circlip is in the free state, the piston is prevented from being ejected from the bore of the housing.

2. The tensioner of claim 1, wherein the bore is in fluid communication with a source of pressurized fluid through an inlet.

3. The tensioner of claim 1, wherein the formed edge is perpendicular to a centerline of the piston.

4. The tensioner of claim 1, wherein the hollow piston has a first, closed end and a second open end comprising a mounting chamfer.

5. The tensioner of claim 1, wherein the expandable circlip is made of steel wire.

6. The tensioner of claim 1, wherein the expandable circlip is a flat, metal band.

7. The tensioner of claim 1, wherein the expandable circlip has at least three lobes and two connecting portions between the first leg and the second leg.

8. The tensioner of claim 1, wherein the expandable circlip has at least four lobes and three connecting portions between the first leg and the second leg.

9. The tensioner of claim 1, wherein the expandable circlip has at least five lobes and a plurality of connecting portion between the first leg and the second leg.

10. The tensioner of claim 1, wherein the expandable circlip has two lobes and a connecting portion between the first leg and the second leg.
